(19) United States
(12) Patent Application Publication
(10) Pub. No.: US 2013/0128550 A1
(43) Pub. Date: May 23, 2013

(54) Backlight Module, Backplane and LCD Device

(71) Applicants: Yicheng Kuo, Guangdong (CN); Yuchun Hsiao, Guangdong (CN); Chong Huang, Guangdong (CN); Jiahe Cheng, Guangdong (CN); Chengwen Que, Guangdong (CN); Quan Li, Guangdond (CN); Liuyang Yang, Guangdong (CN)

(72) Inventors: Yicheng Kuo, Guangdong (CN); Yuchun Hsiao, Guangdong (CN); Chong Huang, Guangdong (CN); Jiahe Cheng, Guangdong (CN); Chengwen Que, Guangdong (CN); Quan Li, Guangdond (CN); Liuyang Yang, Guangdong (CN)

(21) Appl. No.: 13/375,889

(22) PCT Filed: Dec. 1, 2011
(86) PCT No.: PCT/CN2011/083328

§ 371 Date: Dec. 2, 2011

(30) Foreign Application Priority Data
Nov. 18, 2011 (CN) 20110369553.0

(51) Int. Cl. G09F 13/04

(52) U.S. Cl. 362/97.2; 362/97.1

(57) ABSTRACT

The present invention discloses a backlight module, a backplane and an LCD device. The backlight module comprises a backplane, a PCB and locking pieces for fixing the PCB on the backplane; the backplane comprises a frame formed by multiple brackets, and bridges arranged on the brackets. The brackets or the bridges are provided with multiple through holes, and the locking pieces are selectively arranged in the through holes by a fixed structure arranged at the bottom of each locking piece. Because the backplane comprises a frame formed by multiple brackets, the frame is provided with bridges for arranging PCBs and the like, and both the brackets and bridges are formed by combining universal shaped parts. The present invention has the advantage of material saving; the bridges are provided with through holes for arranging hillocks, and the hillocks are arranged in any through hole of the bridges. Thus, the hillocks can be arranged in the through holes in corresponding positions in accordance with the PCB size, so that the backplane can be adapted for PCBs of different sizes or backlight modules with components of different number.

### TECHNICAL FIELD

The present invention relates to the field of liquid crystal displays (LCDs), and more particularly to a backlight module, a backplane and an LCD device.

### BACKGROUND

All the LCD modules produced in batches use integral backplanes. Products become heavy and the material cost of the products becomes high because the products are integrally formed by metal stamping or injection molding in general. Large products require large stamping equipments, and then the cost becomes high; the corresponding die size is large, the structure is complicated, and then the die cost is high. FIG. 1 shows a simplified structure diagram of an existing backplane. The backplane is formed by integrally stamping a block of metal, and the backplane surface is stamped with hillocks 80 for fixing PCBs. The backplane has disadvantages of more consumed material, heavy weight and complicated manufacturing procedure. With the increasingly fierce market competition, it is more and more important to effectively reduce the design cost. Thus, saving material cost and simplifying assembly technology become the crucial research directions of each designer, and then hollow or joined backplane design is developed on the basis of the original integral backplane design, reducing the cost to a certain extent. However, the strength of hollow or joined backplanes is reduced, and then it is difficult to fix the PCB originally fixed on backplane on the hollow or joined backplane.

Hillock(s) is a structure arranged on the backplane and used for fixing the PCB and the like. Generally, the hillock protrudes the backplane surface, and the PCB is fixed on the hillock by screws or other locking pieces, and then the short circuit caused by direct contact between the PCB and the backplane surface is avoided.

An existing backplane is as shown in FIG. 1, and the hillocks 80 on the backplane are integrally stamped and formed on the backplane when the backplane is made. Thus, the positions of the hillocks 80 on the backplane are fixed so it is difficult to adapt for the PCBs of different sizes; meanwhile, for the backlight modules requiring PCBs of different sizes and components of different number, corresponding backplanes are required to be mold-made; and for PCBs of different sizes, new backplanes are required to be mold-made. Thus, the generality of backplanes is poor, and the production cost is high under the condition.

### SUMMARY

The aim of the present invention is to provide a backlight module with advantages of material saving and good generality, a backplane and an LCD device.

The purpose of the present invention is achieved by the following technical schemes. A backlight module comprises a backplane, a PCB and locking pieces for fixing the PCB on the backplane; the backplane comprises a frame formed by multiple brackets, and bridges arranged on the brackets. The brackets or the bridges are provided with multiple through holes, and the locking pieces are selectively arranged in the through holes by a fixed structure at the bottom of each locking piece.

Preferably, the locking pieces can be arranged in the corresponding through holes of the chutes in accordance with the PCB size. By determining the PCB size, the locking pieces are arranged in the corresponding through holes. Thus, PCBs of different sizes can be arranged on the backplanes of the same size.

Preferably, the through holes in the bridges are a series of standard holes, and the locking pieces are selectively fixed in the standard holes. A series of standard holes are easily machined, and are adapted for PCBs of different sizes.

Preferably, the through holes in the bridges are multiple holes correspondingly arranged in accordance with PCBs of various specifications, and the locking pieces are selectively fixed in the multiple holes. Because multiple holes are correspondingly arranged in accordance with the PCB size of various specifications, one backplane is adapted for PCBs of different sizes, and some unnecessary holes are avoided, so that the strength of the backplane is not weakened.

Preferably, each locking piece is an independent hillock, and the bottom of the independent hillock is provided with a fixed structure for arranging the independent hillock in the chute.

Preferably, the fixed structure is a threaded hole arranged at the bottom of the hillock. The hillock can be conveniently arranged on the backplane by screw(s), and can be removed.

Preferably, the threaded hole penetrates through the hillock. Thus, the PCB, the hillock and the backplane can be mutually fixed by only one screw, and the three components are fixed because the screw passes through the PCB, the hillock and the backplane and is tightly locked by a nut.

Preferably, the fixed structure is a rivet integrally arranged at the bottom of the hillock. The riveting mode has advantages of simplicity, convenience, quickness and high reliability, and can be accomplished by machinery.

Preferably, each locking piece is an independent mushroom head. The mode for locking PCB by the mushroom head is convenient and quick.

A backplane, the backplane comprises a frame formed by multiple brackets, and bridges arranged on the brackets. The brackets or the bridges are provided with multiple through holes for arranging the locking pieces.

An LCD device, the LCD device comprises any one of the aforementioned backlight modules.

Because the backplane comprises a frame structure formed by multiple brackets, the frame is provided with bridges for arranging PCBs and the like, and both the brackets and bridges are formed by combining universal shaped parts, the present invention has advantages of low manufacturing cost, and material saving; meanwhile, the brackets or the bridges are provided with multiple through holes for arranging hillocks, and the hillocks are arranged in any through hole of the bridges. Thus, the hillocks can be arranged in the through holes in corresponding positions in accordance with the PCB size, so that the backplane can be adapted for PCBs of different sizes, or backlight modules or LCD devices with components of different number. Therefore, the generality of backplanes of different sizes is increased, the reusability of the dies is increased, and the production cost is reduced.

### BRIEF DESCRIPTION OF FIGURES

FIG. 1 is a simplified structure diagram of an existing backplane;

FIG. 2 is a simplified structure diagram of a backplane of an example of the present invention;

FIG. 3 is a simplified structure diagram of one hillock of an example of the present invention;

FIG. 4 is a structure diagram of a PCB locked by one hillock of an example of the present invention;

FIG. 5 is a simplified structure diagram of another hillock of an example of the present invention;

FIG. 6 is a structure diagram of a PCB locked by another hillock of an example of the present invention; and

FIG. 7 is a simplified structure diagram of a third hillock of an example of the present invention.

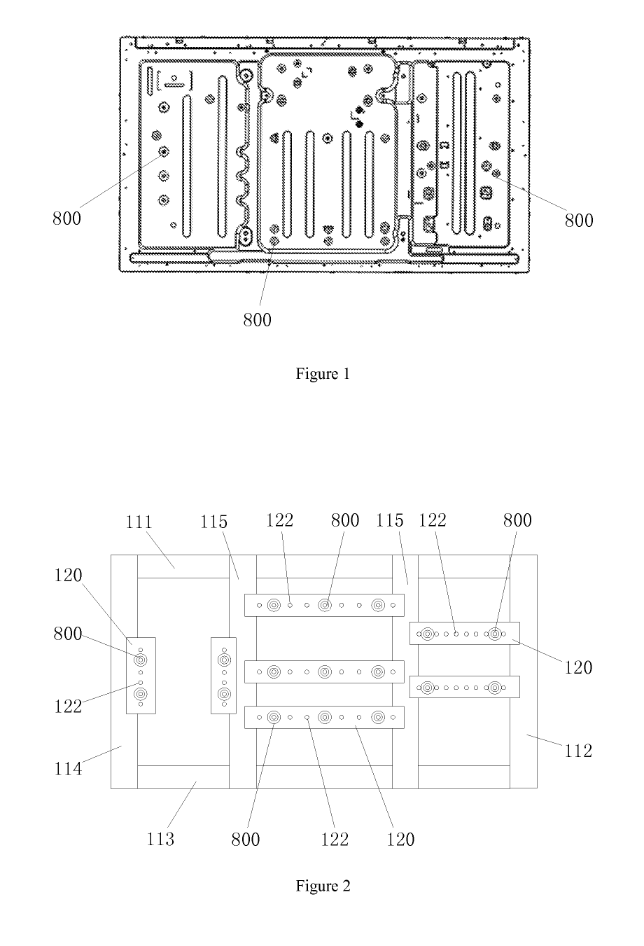

Wherein: 1. backplane; 100. frame; 111. upper bracket; 112 right bracket; 113. lower bracket; 114. left bracket; 115. central bracket; 120. bridge; 122. through hole; 800. hillock; 810. threaded hole; 811. screw; 812. nut; 820. rivet; 300. PCB.

### DETAILED DESCRIPTION

The present invention provides an LCD device. The LCD device comprises an LCD panel and a backlight module. The bottom of the backlight module is provided with a backplane. The backplane comprises a frame formed by multiple brackets, and the frame is provided with multiple bridges. As shown in FIG. 2, the brackets comprise an upper bracket 111, a lower bracket 113, a left bracket 114 and a right bracket 112 which are connected from end to end to form a large frame of the whole backplane, two central brackets 115 are arranged inside the large frame, and both ends of each central bracket 115 are respectively fixed above the upper bracket and the lower bracket. Multiple bridges are arranged on each bracket and between two brackets, and the bridges 120 are used for fixing the PCB and other components of the backlight modules. The bridges 120 are provided with multiple through holes 122, and the locking pieces such as hillocks and the like for locking the PCB are selectively arranged in the multiple through holes 122.

With regard to the scheme, the invention will further be described in detail in accordance with the following preferred examples.

A frame type backplane of the example is as shown in FIG. 2, the backplane is combined into a main frame 100 by multiple brackets and is combined and fixed on the brackets by matching with corresponding bridges 120, and the brackets and the bridges are correspondingly provided with hillocks 800 required for fixing PCBs and the like. In the example, the hillocks 800 are hillocks existing as independent parts in example 1. As shown in FIG. 2, the main frame 100 of the frame type backplane is provided with multiple bridges 120, and the bridges 120 are provided with multiple through holes 122. The through holes 122 can be arranged in the corresponding positions of the bridges 120 in accordance with the size of frequently-used PCBs or other components, namely for the PCB of each size, the bridges 120 are provided with corresponding through holes 122, and hillocks 800 are selectively fixed in the multiple through holes 122 as required. Because multiple holes are correspondingly arranged in accordance with the PCB sizes of various specifications, one backplane is adapted for PCBs of various sizes, and some unnecessary holes are avoided, so that the strength of the backplane is not weakened; alternatively, the bridges 120 are provided with a series of equispaced standard holes, and the standard holes cover the through holes 122 required by PCBs of various specifications so as to facilitate processing, and the hillocks 800 are selectively fixed in the standard holes in accordance with the PCB size. The hillocks 800 as independent existing parts are arranged in the corresponding through holes 122. The hillocks 800 are arranged in the corresponding through holes 122 in accordance with the PCBs of various sizes and specifications. Thus, the PCB of the size is locked on the backplane.

In the example, the through holes can be arranged in the brackets as well, and then more positions for arranging hillocks can be provided, to meet some backlight modules with many components.

Of course, the PCB can be locked on the backplane by other similar locking pieces such as mushroom heads and the like besides hillocks. The mushroom heads are made into independent existing parts and arranged in the chutes as the hillocks, and the PCBs of different sizes are locked in the same way.

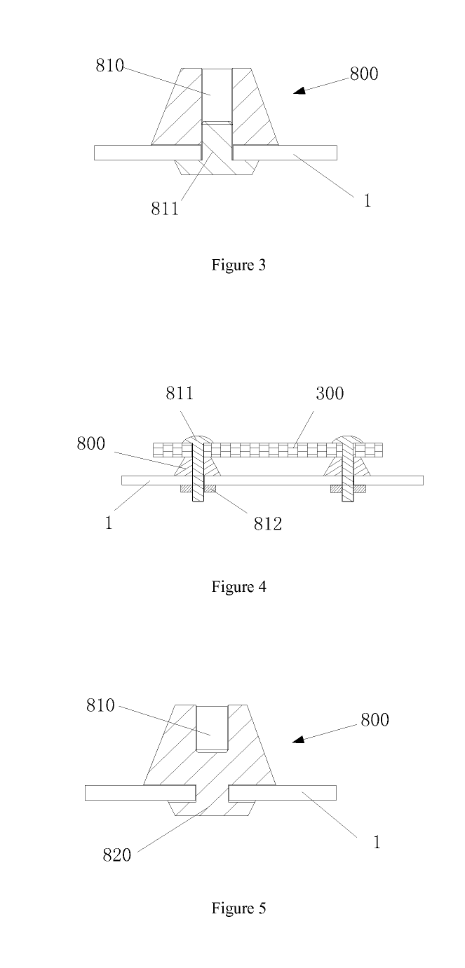

FIG. 3 and FIG. 5 show an hillock 800 existing as an independent part in the example. The hillocks of this type are not formed on the backplane when the backplane is manufactured, but when the hillocks are required, the hillocks 800 are arranged in the corresponding through holes of the backplane 1 to achieve the aim of positioning PCBs and the like of various sizes by flexibly using the hillocks 800.

As shown in FIG. 3, the hillock 800 has a threaded hole 810 for arranging and fixing the PCB and the like, and the threaded hole 810 penetrates through the independent hillock 800. Thus, the independent hillock 800 can be fixed on the backplane 1 from the lower part through a screw 811, and can fix the PCB from the upper part. Accordingly, the backplane 1 is provided with hillock mounting holes, namely through holes, of which the size is corresponding to that of the threaded hole 810 of each hillock 800, so that the hillock 800 can be fixed on the backplane 1. Similarly, the PCB, the hillock and the backplane are fixed by using one screw matching with a nut. As shown in FIG. 4, because the threaded hole penetrates through the whole hillock 800, the PCB 300 is directly locked on the backplane 1 by a screw 811 matching with a nut 812.

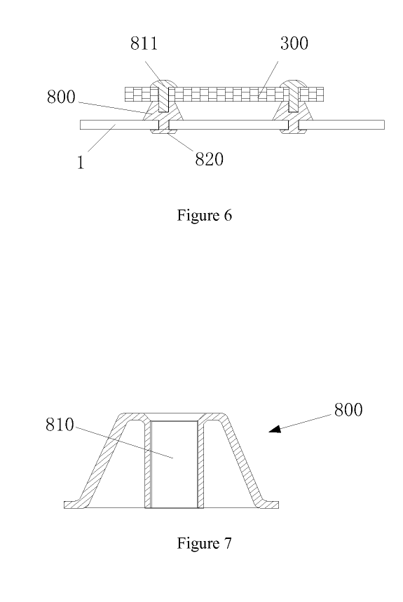

To facilitate installation, as shown in FIG. 5, the bottom of the hillock is designed into a structure similar to a rivet, namely the rivet and the hillock are integrally formed. The lower end of the hillock 800 is connected with the backplane 1 by riveting, namely the hillock 800 is riveted on the backplane 1 by a rivet 820. Relative to the screwing mode, the riveting mode can be quickly achieved, and can be accomplished by machinery so that the production efficiency can be increased. As shown in FIG. 6, the hillock 800 is fixed on the backplane 1 by a rivet 820, and then the PCB 300 is fixed on the hillock by a screw 811 so that the PCB 300 is locked.

To save material and facilitate processing, the hillock can be formed by directly stamping a panel. As shown in FIG. 7, the inside of the hillock 800 is of a hollow structure, and the whole hillock 800 is made of panel material, thus material is saved and the manufacture is convenient.

Of course, the shape of the independent hillock 800 in the example is not limited to the conical section shape as shown in the figure. Other shape such as square can achieve the corresponding use.

In the example, corresponding hillocks are arranged in corresponding positions in accordance with the PCB size of the backlight module; meanwhile, hillocks of corresponding number are arranged and through holes of corresponding number are arranged in the backplane in accordance with the number of different PCB components.

The present invention is described in detail in accordance with the above contents with the specific preferred examples. However, this invention is not limited to the specific examples. For the ordinary technical personnel of the technical field of the present invention, on the premise of keeping the conception of the present invention, the technical personnel can also make simple deductions or replacements, and all of which should be considered to belong to the protection scope of the present invention.

We claim:

1. A backlight module, comprising: a backplane, a PCB and locking pieces for fixing the PCB on the backplane; wherein said backplane comprises a frame formed by multiple brackets, and bridges arranged on said brackets; said brackets or said bridges are provided with multiple through holes, and said locking pieces are selectively arranged in said through holes by the fixed structure at the bottom of each said locking piece.

2. The backlight module of claim 1, wherein said locking pieces can be arranged in the corresponding through holes of said bridges in accordance with the PCB size.

3. The backlight module of claim 2, wherein the through holes in said bridges are a series of standard holes, and said locking pieces are selectively fixed in said standard holes.

4. The backlight module of claim 2, wherein the through holes in said bridges are multiple holes correspondingly arranged in accordance with PCBs of various specifications, and said locking pieces are selectively fixed in said multiple holes.

5. The backlight module of claim 2, wherein each said locking piece is an independent hillock, and the bottom of said independent hillock is provided with a fixed structure for arranging the hillock in said chute.

6. The backlight module of claim 5, wherein said fixed structure is a threaded hole arranged at the bottom of the hillock.

7. The backlight module of claim 6, wherein said threaded hole penetrates through the hillock.

8. The backlight module of claim 5, wherein said fixed structure is a rivet integrally arranged at the bottom of the hillock.

9. The backlight module of claim 2, wherein said locking piece is an independent mushroom head.

10. A backplane, comprising: a frame formed by multiple brackets, and bridges arranged on the brackets; said brackets or said bridges are provided with multiple through holes for arranging the locking pieces.

11. An LCD device, comprising: the backlight module of claim 1; said backlight module comprises a backplane, a PCB and locking pieces for fixing the PCB on the backplane; said backplane comprises a frame formed by multiple brackets, and bridges arranged on the brackets; said brackets or said bridges are provided with multiple through holes, and said locking pieces are selectively arranged in the through holes by the fixed structure at the bottom of each locking piece.

12. The LCD device of claim 11, wherein said locking pieces can be arranged in the corresponding through holes in said bridges in accordance with the PCB size.

13. The LCD device of claim 12, wherein the through holes in said bridges are a series of standard holes, and said locking pieces are selectively fixed in said standard holes.

14. The LCD device of claim 12, wherein the through holes in said bridges are multiple holes correspondingly arranged in accordance with PCBs of different sizes, and said locking pieces are selectively fixed in said multiple holes.

15. The LCD device of claim 12, wherein each said locking piece is an independent hillock, and the bottom of said independent hillock is provided with a fixed structure for arranging the hillock in said chute.

16. The LCD device of claim 15, wherein said fixed structure is a threaded hole arranged at the bottom of the hillock.

17. The LCD device of claim 16, wherein said threaded hole penetrates through the hillock.

18. The LCD device of claim 15, wherein said fixed structure is a rivet integrally arranged at the bottom of the hillock.

19. The LCD device of claim 12, wherein said locking piece is an independent mushroom head.
